(19) United States
(12) Patent Application Publication
(10) Pub. No.: US 2005/0199636 A1
(43) Pub. Date: Sep. 15, 2005

(54) Silicone-rubber plate used in an oven

(76) Inventor: I-Wen Liu, Taipei City (TW)

Correspondence Address: I-Wen Liu, P.O. Box 90, Tainan City, 704, TW

(21) Appl. No.: 10/799,125

(22) Filed: Mar. 9, 2004

(51) Int. Cl. H01H 9/04

(52) U.S. Cl. 220/644

(57) ABSTRACT

A silicone-rubber plate used in an oven includes an plate body, a projecting circumferential edge formed around the plate body and containing a metal bar therein, two pairs of upper ears and of lower ears formed on the outer vertical surface of the plate body and facing each other and respectively having a through hole, and plural U-shaped support bars crossing each other and propping the lower side of the plate body and respectively having two ends inserting firmly in the through holes of the upper and the lower ears of the plate body. Then the plate is supported by the support bars and the metal bars so that the plate may not disfigure when held up, keeping intact its flat shape, preventing soup therein from overflowing and keeping intact the appearance of baked food thereon and to hamper food from falling off.

### BACKGROUND OF THE INVENTION

1. Field of the Invention

This invention relates to a silicone-rubber plate used in an oven, particularly to one having a projecting circumferential edge, and a metal bar contained lengthwise in the projecting circumferential edge, at least two pairs of upper ears and of lower ears formed on an outer vertical surface and respectively provided with a through hole for securing two ends of the support bars propping the lower side of the silicone-rubber plate. Thus, the plate may not disfigure or has its intermediate portion drooping down by means of the metal bar and the support bars propping to keep the plate flat enough so as to prevent soup in the plate from overflowing, and to keep baked food intact thereon without altering its appearance and falling out of the plate.

2. Description of the Prior Art

A traditional silicone-rubber plate used in an oven 1 shown in FIG. 1 is very soft to easily disfigure, crack, break, etc., so that the material such as dough being baked thereon may be deteriorated in its appearance, or fall out of the plate. And some traditional silicone-rubber plate may have a thick circumferential projecting edge 10 or plural ribs 11 formed on its outer surface for reinforcing the plate. However, these additional structures are not so effective to reinforce the traditional plate to overcome the disadvantages mentioned.

### SUMMARY OF THE INVENTION

The main objective of the invention is to offer a silicone-rubber plate used in an oven, which can maintain its shape flat and not disfigure when it is held up manually so as to prevent soup in the plate from overflowing and keeping the appearance of the food such as bread baked intact or hampering the food from falling out of the plate.

A first feature of the invention is a meal bar contained in a projecting circumferential edge of a silicone-rubber plate.

A second feature of the invention is an inlet formed in the circumferential edge for the metal bar to be inserted therein, and a securing member provided at the inlet for securing the metal bar stably.

A third feature of the invention is at least two pairs of upper ears and of lower ears formed in an outer vertical surface and each upper and lower ear provided with a through hole, and at least two support bars provided crossing with each other for propping the lower side of the plate and two ends of the two support bars are hooked respectively with the upper and the lower ears.

### BRIEF DESCRIPTION OF DRAWINGS

This invention will be better understood by referring to the accompanying drawings, wherein;

FIG. 1 is a perspective view of a traditional silicone-rubber plate used in an oven;

FIG. 2 is an exploded perspective view of a first embodiment of a silicone-rubber plate used in an oven in the present invention;

FIG. 3 is a perspective view of a metal bar contained in a projecting circumferential edge of a silicone-rubber plate used in an oven in the first embodiment in the present invention;

FIG. 4 is a partial cross-sectional view of a support bar combined with a plate body in the first embodiment in the present invention;

FIG. 5 is a perspective view of a metal bar provided in another way in the first embodiment in the present invention; and,

FIG. 6 is an exploded perspective view of a second embodiment of a silicone-rubber plate used in an oven in the present invention.

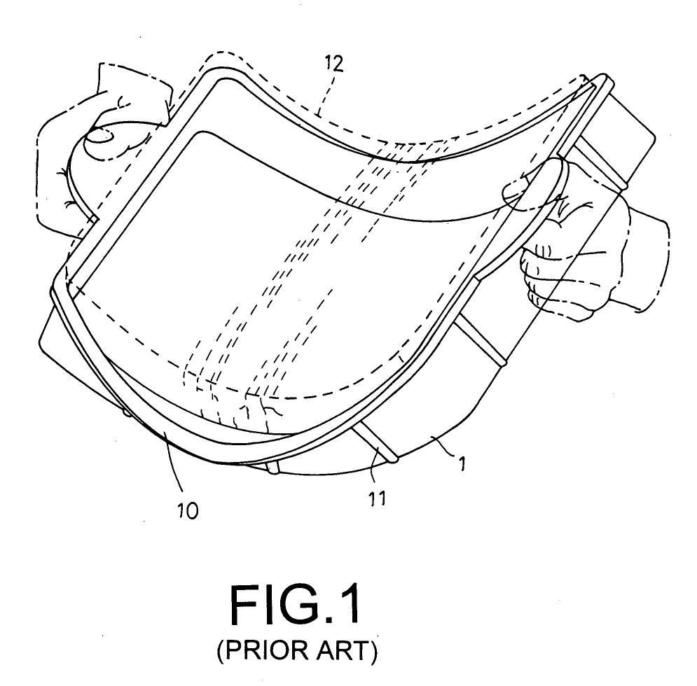

### DETAILED DESCRIPTION OF THE PREFERRED EMBODIMENT

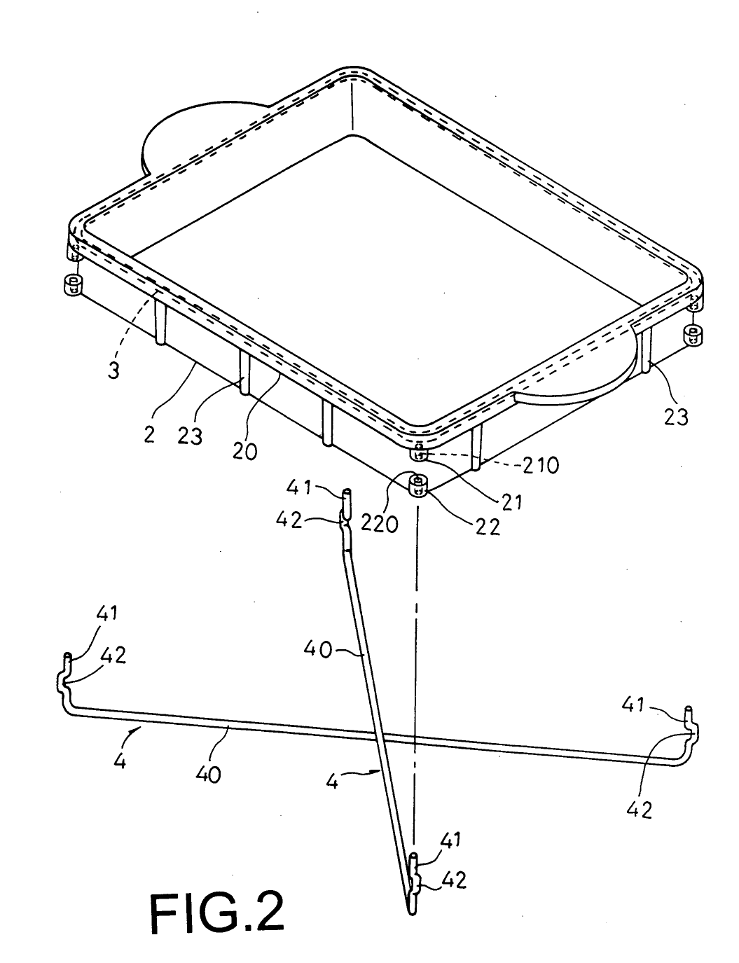

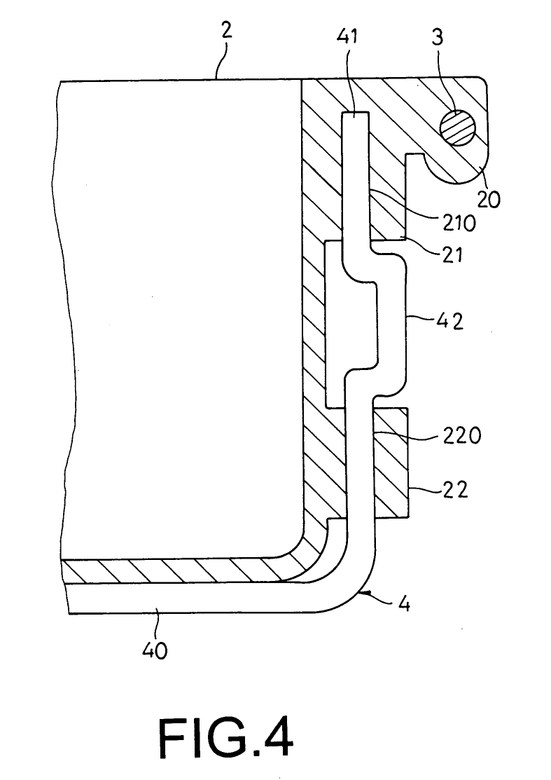

A first embodiment of a silicone-rubber plate used in an oven in the present invention, as shown in FIGS. 2, 3 and 4, includes an plate body 2, a projecting circumferential edge 20, a metal bar 3 contained in the circumferential edge 20, at least two upper ears 21 and two lower ears 22 provided facing each other on an outer vertical circumferential surface and respectively having a through hole 210, 220, plural ribs 23 formed spaced apart on the outer vertical circumferential surface for strengthen the plate body. Further, the plate has plural U-shaped support bars 4 made of metal, which respectively have a support area 41 and two combining ends 41 with a recess 42 in its intermediate section.

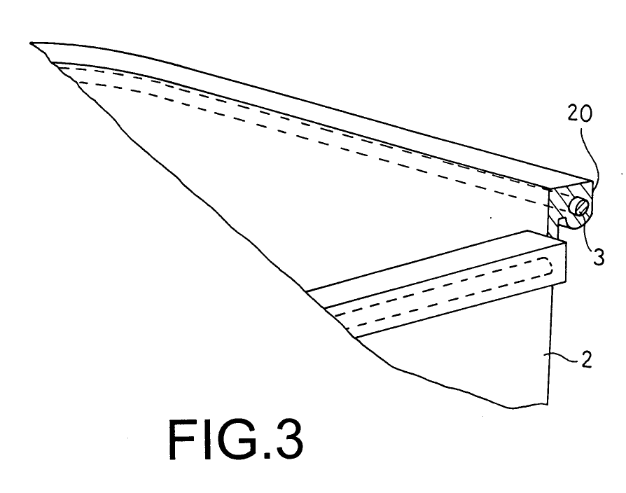

In assembling, firstly, the support bars 4 have their combing ends 41 inserted in the through holes 210 and 220 of the upper and the lower ears 21 and 22, with the recess 42 located between each upper ear 21 and each lower ear 22 to secure the metal bars 4 with the plate body 2 and with the support area 40 propping the lower side of the oven body 2, and with the tips of the combining ends 41 sticking in the wall of the plate body 2 near the metal bar 3, as shown in FIG. 3. As the soft silicone rubber has some adhering force to bind the support bars 4, with the metal bars 3 cooperating with the ribs 23, augmenting the stress and the tension in the directions of X and Y axes. Therefore, when a user holds up and moves away the silicone-rubber plate 2 after the food is baked enough, the oven may not disfigure owing to its softness because of the metal bars 3 functioning as a hard frame and the support bars 4 propping the lower side and the side wall of the plate body 2. In addition, soup in the plate will neither overflow the oven, with the food kept intact without altered in its shape or falling off.

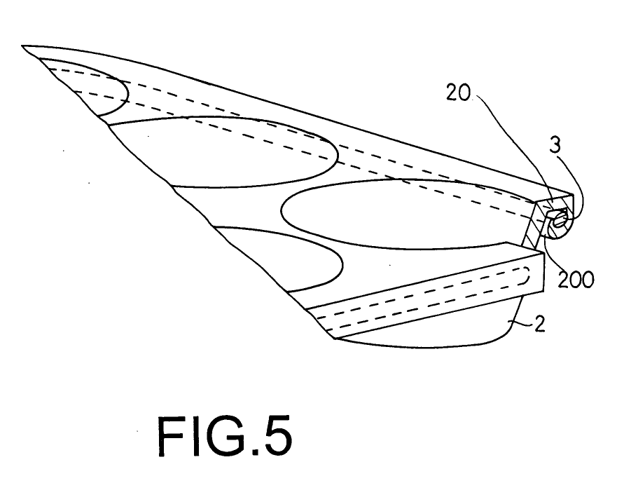

Moreover, the projecting circumferential edge 20 can be provided with an inlet 200 as shown in FIG. 5, to let the metal bar 3 possible to be inserted in the interior of the edge 20.

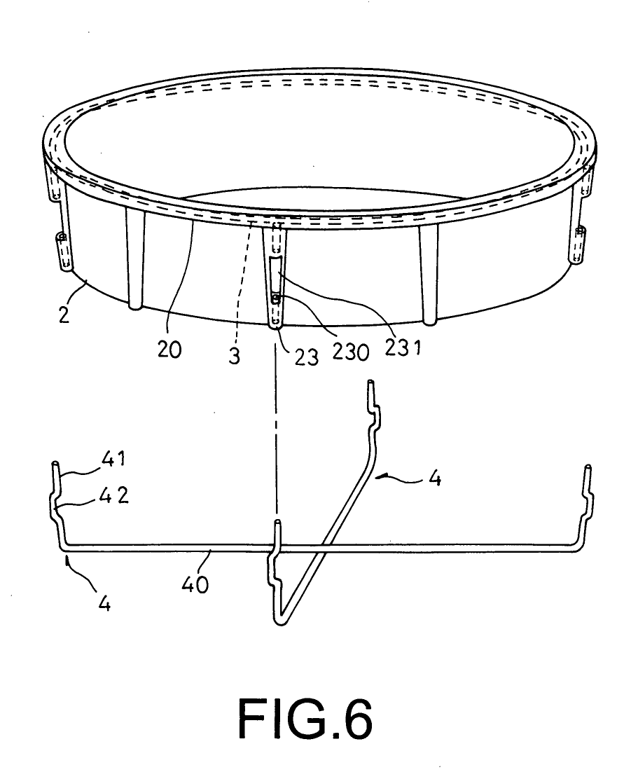

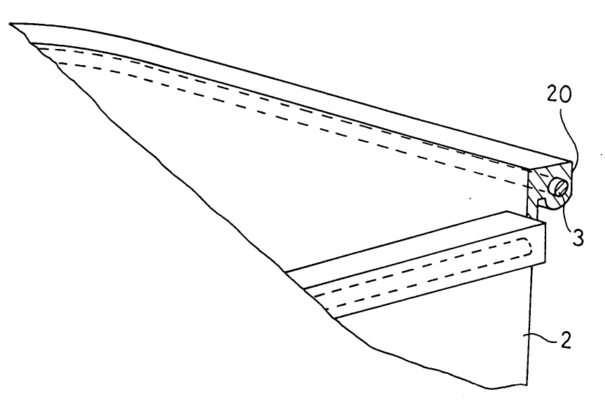

In addition, FIG. 6 show a second embodiment of a silicone-rubber plate used in an oven, having almost the same structure, except that the ribs 23 further have respectively a straight hole 230 for the combining ends 41 of the support bars 4 to insert therein, and an opening 231 formed in the intermediate section of each rib 23 for the recess 42 of each support bar 4 to stick out, securing the support bars 4 with the plate body 2.

While the preferred embodiments of the invention have been described above, it will be recognized and understood that various modifications may be made therein and the appended claims are intended to cover all such modifications that may fall within the spirit and scope of the invention.

1. A silicone-rubber plate used in an oven, said plate comprising a projecting circumferential edge, a metal bar contained in said circumferential edge; said plate not disfiguring when it is held up by a user and keeping its flat shape so as to prevent soup in said plate from overflowing and to maintain intact the appearance of baked food placed on said plate and also to hamper food thereon from falling off.

2. A silicone-rubber plate used in an oven, said plate comprising a projecting circumferential edge, said circumferential edge having an inlet, a metal bar inserted through said inlet to extend lengthwise in the interior of said circumferential edge; said plate not disfiguring and able to maintain its flat shape so as to prevent soup in said disc oven from overflowing and also to keep intact the appearance of the hood baked on said disc oven and also to hamper food from falling off when said plate is held up.

3. A silicone-rubber plate used in an oven, said plate comprising at least two pairs of upper ears and of lower ears provided on an outer vertical circumferential surface, each said upper and lower ear having a through hole; said plate further having at least two support bars crossing each other, said support bars propping a lower side of said plate and having its two ends inserted securely in said through holes of said upper and said lower ears; said plate not disfiguring so as to maintain intact its flat shape and to prevent soup therein from overflowing and baked food placed on said plate possible to be kept intact and also prevented from falling off said disc oven when a user holds up said plate.

4. The silicone-rubber plate used in an oven as claimed in claim 3, wherein each said support bar is U-shaped, having a support area for propping a lower side of said plate and two combining ends provided respectively with a recess in the intermediate section.
